(19) United States
(12) Patent Application Publication
(10) Pub. No.: US 2023/0125407 A1
(43) Pub. Date: Apr. 27, 2023

(54) System and Process for Controlling and Verifying Transactions

(71) Applicant: Renjit Sundharadas, San Diego, CA (US)

(72) Inventor: Renjit Sundharadas, San Diego, CA (US)

(21) Appl. No.: 17/964,586

(22) Filed: Oct. 12, 2022

Related U.S. Application Data
(60) Provisional application No. 63/271,526, filed on Oct. 25, 2021.

(51) Int. Cl. G06Q 20/40; G06Q 20/20; G06Q 20/32; G06Q 20/38

(52) U.S. Cl. CPC G06Q 20/4014; G06Q 20/20; G06Q 20/3276; G06Q 20/389; G06Q 20/405; G06Q 20/407

(57) ABSTRACT

A system and process for controlling and verifying transactions has a central registry that includes one or more servers configured to retrieve and store registration information in a database. Registration terminals in communication with the central registry allow for registration of a participant in a program to track and limit consumption. Point-of-sale terminals communicate with the central registry to request authorization for a purchase. In an authorization request, the point-of-sale terminal communicates the identity of the prospective purchaser to the central registry, which in turn attempts to match the purchaser to a registered participant. In the case of a match, the central registry looks up the participant's purchase restrictions, and if the participant is restricted from a product or service that is being purchased, the central registry refuses authorization to complete the purchase, and the registered participant is prevented from purchasing the product or service.

### RELATED APPLICATIONS

The present application claims the benefit of priority to U.S. Provisional Patent Application, Ser. No. 63/271,526 titled “System and Process For Controlling and Verifying Transactions”, filed Oct. 25, 2021, and currently co-pending.

### FIELD OF THE INVENTION

The present invention pertains generally to behavior tracking for use in limiting and/or modifying transactions and services. More particularly, the present invention pertains to a system and process for controlling and verifying transactions. The Present invention is particularly, but not exclusively, useful as a method of limiting access to addictive substances or services.

### BACKGROUND OF THE INVENTION

There are approximately 34 million smokers in the United States and countless other millions across the globe. 70% of smokers in the US would like to quit but are unable to given the addictive nature of nicotine products. Just as the availability of food contributes to obesity, the ability to purchase tobacco products allows a person to easily relapse.

Consumption of nicotine products and excessive alcohol consumption creates a burden on the healthcare system, which affects both the consumer and other parties. For example, use of tobacco products can interfere with spinal fusion surgery success. Healthcare costs are increased for everyone as the healthcare system becomes burdened with patients who have diseases or accidents that could have been avoided.

In addition to burdening the healthcare system, excessive consumption of alcohol and use of nicotine products create an insurance burden that can result in higher costs for health and life insurance, and, in the case of alcohol consumption, auto insurance.

In light of the above, it would be advantageous to provide a tool for making relapse difficult for a person seeking to overcome an addiction.

### SUMMARY OF THE INVENTION

Disclosed is a system and process for controlling and verifying transactions. A central registry includes one or more servers configured to retrieve and store registration information in a database. Registration terminals in communication with the central registry allow for registration of a participant in a program to track and limit consumption. Point-of-sale terminals communicate with the central registry to request authorization for a purchase. In an authorization request, the point-of-sale terminal communicates the identity of the prospective purchaser to the central registry, which in turn attempts to match the purchaser to a registered participant. In the case of a match, the central registry looks up the participant's purchase restrictions, and if the participant is restricted from a product or service that is being purchased, the central registry refuses authorization to complete the purchase, and the registered participant is prevented from purchasing the product or service.

In using the system, registered quitters of tobacco products register and as part of the registration they are not able to purchase tobacco products, or, for quitters whose use is only occasional, are limited in purchasing tobacco products. With the whole temptation of being able to buy tobacco now gone, they are much more likely to successfully quit. The time period for such a restriction can be any length but in most cases is at least one year to a person's whole lifetime. In some embodiments, when someone wants to deregister as a non-user there is a waiting period so that they are forced to reconsider. This waiting period also makes sense because if someone can just on the spur of the moment exit the commitment it wouldn't be as beneficial with regards to reducing substance use. It also applies to other tobacco products such as chewing tobacco, vapes, e-cigarettes as well as any related product. In use, vendors scan identification (identifying information) of the purchaser or person who enters venues where such products are sold and deny purchase of these substances to registered quitters. For low users the system keeps track of the purchases and limited purchases are allowed. These limitations vary in types such as cigarettes vs. vaping, as well as quantity.

The system also offers benefits to insurers, especially auto, health and life insurers, and provides a venue for people to justify lower rates by clearly being limited by their abilities to purchase tobacco or alcohol products. At this point many tobacco users lie on their health insurance applications. Also, certain medical indications such as asthma and spinal fusion can motivate the limitation of quantities are limited or prohibition of purchase of tobacco products. For example, the system enables asthmatics to have tobacco restricted or taxed to prevent ER visits and spinal fusion patients to have tobacco purchases prohibited as tobacco use interferes with spinal fusion surgery success. Some embodiments implement reporting of purchases to insurers, and it is reasonable to restrict certain people in this type of system if they are receiving insured care in order to preserve good clinical outcomes. Some embodiments facilitate the attachment of taxes and debts such as unpaid taxes or school lunch fees. Taxes can also be progressive and thus help limit the volume of purchases as well as resale. For example, in an exemplary preferred embodiment, someone who smokes or drinks pays a progressively higher tax.

Regarding alcohol, the system enables venues to restrict entry from persons convicted of alcohol related crimes such as DWI, public intoxication, or other offenses in order to limit liability. Some embodiments of the system show a reason for the determination of entry or any other decision, while other embodiments withhold that information. In some cases, Alcohol is allowed in limited quantities for purchase for those detoxifying so that they don't go into alcohol withdrawal. Eventually alcoholics who are taken off of alcohol can be prohibited from buying alcohol which would also reduce the liability of those selling alcohol. This also improves the health and economic condition of the alcoholic. Such information is useful for auto insurers when amounts of alcohol purchase are shared with them. It can also be used by those selling alcohol (in retail or venue locations) in real time to restrict to some extent the overuse of alcohol. Sellers of alcohol have a liability if they sell to someone who is involved in a drunk driving incident. Thus, preferred embodiments of the system have the capability of notifying the seller if the patient has had a DUI or a predetermined amount of alcohol and thus restrict entry or sales of alcohol. Finally, those that wish to discontinue or limit the use of alcohol have options. Prohibition or limitation of alcohol purchase can be used in exchange for reinstating driving privileges. In other words, as a condition of restoration of a driver's license or any other objective the person agrees to register as a non-user or limited user. Additionally, tracking of purchases is done in real time as an aid in determining if alcohol should be sold or dispensed. In some embodiments, one can link either a designated driver or ride sharing/taxi service to the consumption of alcohol in restricted persons. In such cases money could be allocated towards a ride home for those consuming alcohol. This would be especially relevant for bars or other venues that sell alcohol. A real time system helps to limit consumption of alcohol in real time to reduce DWI. Studies have affirmed that drinking outside the home correlates to higher rates of drinking and driving. Some preferred embodiments of the system are capable of restricting alcohol based on the time of the day. Twenty nine percent of DWI drivers are repeat offenders. Such a real time system is capable of limiting drinks for those who do not have some designated ride home. Some embodiments are populated with height, weight and other factors, which are used to determine the drink limits. As parts of legal settlements, a person can be prohibited from using alcohol and have to turn over whatever stock they have. Also, one can be warned about excessive use of alcohol or tobacco. Vaccine or other information may be verified by identification or an identifier. This includes information about the individual and relatives of the individual. For example, and adult's identification can be used to verify vaccination of children or others in the residency.

Since a system like this tracks use, a person's alcohol intake can be tracked over multiple locations over time. Preferred embodiments have real time usage on a daily basis to prevent DUI or other consequences. The tracking of usage allows society to intervene in a person's life to help turn it around before the person reaches rock bottom.

The fact that a waiting period for restarting use exists helps keep the person off of a tobacco, alcohol, gambling or other addictive behavior. In preferred embodiments, the restarting criteria is not hard-coded, but allows variables to be applied. For example, one can require a relative, or responsible party to agree for the person to restart use. This is useful for alcohol or gambling addiction. The responsible party could be a relative, court/legal body, or healthcare professional.

Health care or other assistance may require participation in such a program. A friend or relative of a person who is receiving help may require them to be part of a quitter program in exchange for the aid offered. They may also be part of a required process to exit the system which makes the agreement compelling and increases the likelihood that people will offer assistance.

Some exemplary uses of the disclosed system include the following:

A person who desires to quit smoking visits a health care professional or other point of service. There, they are set up to be a registered quitter and can no longer buy tobacco or related products. There can be a start date in the future for this with purchases being limited up until that start date. Ideally the start date/time would be immediate. They sign up to be a registered quitter for a period of time up to a lifetime commitment. This time period may expire but preferred embodiments of the system include an option for it to auto-renew at any time. For example, one signs up to be a quitter for 12 months, but at month 6, the quit date is automatically extended 6 months. Any permutation of this extension is facilitated by the system. The use or tobacco paraphernalia can be limited or banned for the individual using this system.

The person wanting to exit the system has a waiting period of any variable time, configured at registration. So, if they wanted to exit the system they would go to a point of service and then they could exit the system with a waiting period such as 1-3 months and/or a monetary fee. This waiting period makes the commitment to quit more serious as they can't just get off the system immediately which improves the effectiveness of the system. Points of service include health care locations, sales of tobacco locations, or any other location able to process this request. It could also occur when someone signs up for healthcare coverage. Someone who does not smoke can sign up as a registered quitter and that information is provided to health insurance carriers for lower rates.

Furthermore, the system facilitates the attachment of debts as surcharges, so that someone who owes back taxes, child support, school lunch debt, etc. can have an amount added to the purchase to pay off the debt or refused purchase based on the debt. There can also be progressive taxation with purchases to more correlate taxes with usage consequences. This helps reduce the risk of one person purchasing tobacco for another person who is a registered quitter. Some preferred embodiments of this system are also be attached to payment methods or other identifiers such as a loyalty card so that, for convenience, the payment method/identifier can be used in verification instead of the ID. A tax can be added to pay for the registered quitter system and insurance carriers could also pay in since they would save money on healthcare expenditures. Some embodiments of the registered quitter system are configured for integration with the DMV and information on use is sent to health insurance companies in some embodiments. Furthermore, the system facilitates making being a registered quitter a condition for parole or be conditional in other situations. A hotel or other rental could be verified or predicated on one's status in the system.

When someone is obtaining health insurance their coverage can be linked to this system. They could pay an appropriate rate if they are or are not using tobacco and any tobacco purchases could be reported to health insurance carriers. This would be beneficial as many smokers lie on their application in order to pay non-smoking rates. This is also important when it comes to Medicare and Medicaid who bear the burden of a lot of the related expenses. Governments can use the system to add additional fees to tobacco purchases if the person has government-based coverage. Preferred embodiments of the system also support address-based restrictions so that no one at a specific address can purchase tobacco or another restricted product, since this prevents others from buying for the person and is useful for restricting or limiting online deliveries. Parents whose adult children are on their insurance policies can have to have them registered as non-users as a condition of extension of coverage for children. Thus, even non-smokers benefit from this system by registering as a quitter. This doesn't affect their daily life but can reduce their insurance premiums.

A person who must reduce or eliminate alcohol visits a health care professional or other point of service. There, they are set up to be a registered quitter and can no longer buy alcohol or related products, such as products for producing their own alcohol/paraphernalia. This would likely occur during a moment of clarity when they realize the bad effect the alcohol is having on them. In other circumstances, it is the result of a legal action. They can also assign a relative or responsible party to also agree in order to enter the process of deregistering. This means that if they want to exit the system, their relative or responsible party must agree, and this would make them less likely to exit the system. By using limited use options of the system, they can undergo a period of tapering on alcohol dispensing to avoid withdrawal. A start date is set in the future for this, with purchases to be limited up until that start date. Ideally the start date would be immediate. They would sign up to be a registered quitter for a period of time up to a lifetime commitment. This time period can be set to expire, but preferred embodiments of the system include an auto-renewal option. For example, one could sign up to be a quitter for 12 months but at month 6, the quit date is automatically extended 6 months. The system's per-user configuration options allow for any permutation of this extension. In some use cases, the registration of the registered quitter for alcohol is court ordered and involuntary. It can be done with the cooperation of medical personnel treating alcoholism. The use of alcohol paraphernalia can be limited or banned, preventing registered quitters from producing alcohol. Such as system tracks purchases so volume of usage can be tracked. A user can share this with the government. The system detects overuse and provides this information to parties, such as the government, to whom the quitter is sharing purchase-tracking, in order to have people treated for alcoholism. Also, if this information is shared with the government or insurance policy it could result in lower fees based on low usage. Those who wish not to share may have to pay more. Criminal infractions such as driving while intoxicated or public intoxication could result in involuntary placement in a registered quitter program.

One application relates to when alcoholics stay at a hotel. There are often alcoholic beverages available for purchase in rooms. With a registered quitter these would have to be locked and closed off so alcohol could not be seen or preferably removed from the room entirely. Also, it is possible for alcohol to be allowed in limited quantities. This would be for safety for a non-alcoholic or also to help prevent alcohol withdrawal. Homeless people could also be added to the registered quitter system to help prevent public drinking issues.

In some situations, the person who wants to exit the system has a waiting period of a predetermined time period selected at registration. So, if they wanted to exit the system they would go to a point of service and then they could exit the system with a waiting period such as, as a non-limiting example, 1-3 months and/or a monetary fee. Examples of points of service include health care locations, locations where alcohol is sold, and other locations able to process this request. It can also occur when someone signs up for healthcare coverage.

Furthermore, debts can be attached to this system so someone who owes back taxes, child support, school lunch debt, etc., can have an amount added to the purchase to pay off the debt or be refused the ability to purchase based on the debt. The system also supports progressive taxation or surcharges with purchases. This helps reduce the risk of one person purchasing alcohol for another person who is a registered quitter. This system can also be attached to payment methods so the payment method can be used in verification instead of the ID. A tax could be added to pay for the registered quitter system and insurance carriers could also pay in since they would save money on healthcare expenditures. Some preferred embodiments of the registered quitter system are configured for integration with the DMV and information on use could be sent to health insurance companies. To promote not driving after drinking, a variable and possibly progressive surcharge can be added to each drink goes towards a rideshare or other service to drive the person to their next destination. After time any excess is refunded and the fee varies based on the expense of transportation based on distance or other factors. Furthermore, being a registered quitter can be a condition for parole or be conditional in other situations.

When someone is obtaining health insurance their coverage can be linked to this system. Preferred embodiments of this system support address-based registration so that no one at a specific address can purchase alcohol. This system can be used to prevent someone from entering or being served in establishments that serve alcohol.

This system is also used identically for people with a gambling addiction. In a preferred embodiment, there is a set legal limit for gambling losses after which a mandatory process ensues as to if the person has a gambling addiction. Then that person is involuntarily be entered into a registered quitter system where gambling is limited or completely banned; a person can also voluntarily register in the system. It would be similar to the cessation program for tobacco and alcohol in all aspects. Also, prospective lenders or others with a vested interest can mandate participation in a quitter program for a gambling addiction. The system is configured to track gambling losses per person, allowing the state to intervene if losses meet a set amount. Per-person limits can be adjusted for individuals, allowing a process to be put in place for affluent gamblers who want to have a higher loss limit.

Similarly, this system allows participants to voluntarily release to auto and health insurance companies the licenses possessed. The stakeholders would be anyone who drives. For instance, a preferred embodiment of the system allows a person to have their health insurance link to the DMV and then verify that they don't have a motorcycle license. This allows for a lower rate for health insurance compared to someone who does not disclose or who has a motorcycle license.

This system is also useful when applied to food with regards to an individual or the address that they live in. Since weight control is very difficult, the purchase of items can be limited to help aid in weight loss and a healthy diet. Nowadays with food delivery and pick up some can enter their identifying information online and then only be presented with healthier options. This is useful to help avoid people from buying items that are unhealthy since they wouldn't enter the store and look at everything.

Finally, some embodiments of this system are configured to carry healthcare information. This includes limited or detailed information, depending on the embodiment. A preferred embodiment mainly carries limited important information such as allergies, medications, medical history and vaccination information. Using an ID card and a reader, the system helps in a healthcare setting or if admission to a venue or other entity must verify a vaccination status. It is important to realize that such a system is not limited to vaccination status. It is capable of including drug screens and scheduled medication prescribing/dispensing. Medical reports can be associated with a registered user in the system.

A system like this is useful to help prevent people from hitting rock bottom. If an alcoholic has a relative who wants to help them, this system allows them to do so with some guarantees. For instance if the alcoholic is homeless, then their relative can agree to help them if they become a registered quitter and also stipulate that they would need to agree for the person to deregister. One of ordinary skill in the art will recognize that there are many possible permutations of such an arrangement.

If someone does not want their ID scanned, they can scan it on their cell phone themselves and then display identifying information or an identifier such as a QR code. This can then be scanned by the merchant to identify a registered user in the system.

These systems have many motivated stakeholders. In the case of tobacco, the person wanting to quit, insurers, government, and people who want lower rates on health insurance by showing they don't smoke all stand to benefit. The insurers and government will have large cost savings in health care costs and society benefits from increased productivity. Smoker's themselves could save thousands and extending their lifespan on average 12 years. Regarding the alcohol cessation program that would benefit the alcoholics themselves as well as make the roads safer. It would also help people lower their health insurance costs when they disclose that they don't ride a motorcycle. Essentially there are many stakeholders that benefit from such a system.

Will power simply will never be enough when it comes to addiction since populations have to be treated and they won't all be able to resist alcohol. In preferred embodiments, a location or even credit card in addition to identification can be used to register a quitter. End users may want to register as non-smokers or someone who doesn't have a motorcycle license in order to obtain discounts on health insurance. This could also be useful to medicare or Medicaid populations. Thus, this flips the whole insurance industry on its head with regards to discount pricing. People could use a system to prove vaccination and obtain discounts, tax benefits or other benefits. Additionally, one could agree to have their usage monitored or not. This may entitle them to insurance discounts but also could be related to licensing issues as well as employment. For example, an airline may require their pilots' usage to be tracked before flights and possibly restricted. A trucker could be required to have alcohol tracked. A registered quitter does not have to be an on/off situation and can be restricted by date or time based on employment or other issues.

Food avoidance may also be part of a registered quitter program. In such a circumstance they would purchase food online and only be shown healthy options or when at an establishment only be shown a menu or be able to buy healthy options.

In some embodiments, these types of options are implemented over a cell phone. If someone does not want to hand over their identification card or have it copied, they could use an app to scan their ID and generate a QR or other code that could then be read at a point of transaction. Finally, this system could also be implemented for video games or any other addictive product or service.

Regarding smoking and alcohol especially, or any issue, an insurance plan could force a registered quitter status for coverage or procedures, medications, visits, or other expenditures. Smoking interferes with spinal fusion so in order for a surgery to be approved it could be required that the patient is in the registered quitter program. Also, one could require someone to quit alcohol and/or tobacco for opiates or even the visit where they are prescribed to be approved. They could require notification and cancellation of benefits if one does not comply with a registered quitter program as a condition for providing insurance. Results of urine or other drug tests could also be added to the system.

There are many ways one can register for this system. In some preferred embodiments, automatic registration based on non-use such as with tobacco is available. In some embodiments, a person is provided the option to register for low or no use when signing up for insurance. Additionally, preferred embodiments allow a user to have purchases banned at certain locations such as bars, sporting events, etc. These events are often more associated with driving.

Various embodiments of the present invention are applicable to all types of insurance. More particularly, the system is useful to an insurance carrier that, as part of its agreement, has a behavioral requirement that is verified. For example, a healthcare policy would be altered if the person registers a motorcycle or obtains a motorcycle license as this potentially increases expenditures for the health insurance company. Additionally, the system supports a healthcare insurance policy that, as part of their agreement, does not allow the participant to obtain a motorcycle license or register a motorcycle. These restrictions would be valid as they are in the form of an agreement.

Similarly, the health insurance agreement would be altered if someone changes their status with regards to tobacco, alcohol or any other tracked substance or service. Through the system, an auto insurance company is able to alter rates based on someone's alcohol status, and tracked consumption. Additionally, since smoking causes 5% of dwelling fires, home and renter's insurance rates are able to be altered based on one's smoking status, and tracked consumption.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a diagram of a system for controlling and verifying transactions;

FIG. 2 is a diagram of a central registry of a system for controlling and verifying transactions;

FIG. 3 is a diagram of a server of the central registry;

FIG. 4 is a diagram of a registration terminal configured for operation with a system for controlling and verifying transactions;

FIG. 5 is a diagram of a point-of-sale terminal configured for operation with a system for controlling and verifying transactions;

FIG. 6 is a flowchart illustrating a registration process performed with a registration terminal in communication with a registration server;

FIG. 7 is a flowchart illustrating the portion of the registration process performed by a registration server;

FIG. 8 is a flowchart illustrating a verification process performed with a point-of-sale terminal in communication with a verification server;

FIG. 9 is a flowchart illustrating the portion of the verification process performed by a verification server;

FIG. 10 is a diagram illustrating the designation of a designated driver through mobile computing devices; and

FIG. 11 is a diagram for a system for controlling and verifying transactions with multiple central registries and networks.

### DETAILED DESCRIPTION

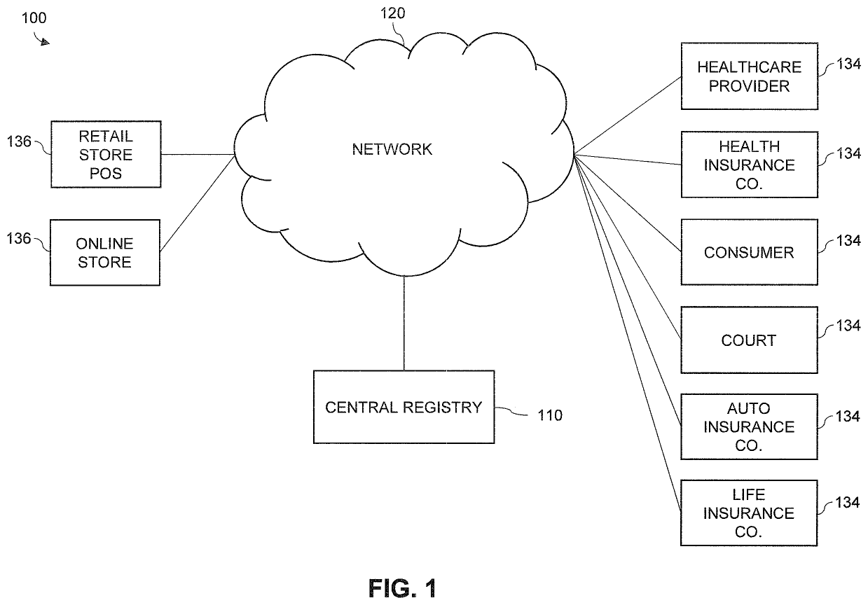

Referring initially to FIG. 1, a preferred embodiment of a system for controlling and verifying transactions is illustrated and generally designated 100. System 100 has a central registry 110 that receives registration data for participants in a program to track and control consumption and authorizes or rejects transactions for a registered participant.

A network 120, such as the Internet or another private or public network, allows registration terminals 134 and point-of-sale terminals 136 to communicate with central registry 110.

Registration terminals 134 communicate with central registry 110 through network 120 in order to register a new participant in a program for tracking and controlling consumption, removing a participant, or updating the limitations placed on a participant. Exemplary use cases for terminals 134 are healthcare providers; health insurance companies, courts, auto insurance companies, life insurance companies, and consumers themselves, as well as other parties that might have an interest in a person's participation in a program. In an exemplary use case, a healthcare provider provides its clients the ability to register in a “quitter” program that results in vendors denying purchase of an addictive substance, such as tobacco products or alcohol, as non-limiting examples, to the registered client. In another exemplary use case, a court registers or requires registration of a person convicted of an alcohol-related crime, resulting in the denial of sales of alcohol to the person convicted. In yet another exemplary use case, an insurer offers registration to its customers and provides a lower rate in exchange for registration in a program that lowers the risk for the insurer; for example, an auto insurer would offer a lower rate to customers who register in a program to limit alcohol purchases, or require registration as a prerequisite to insurance for a potential customer with convictions for driving while intoxicated (DWI) or similar offenses.

Point-of-sale terminals 136 communicate with the central registry 100 through network 120 in order to verify that a customer is not restricted from purchase of an item or use of a service.

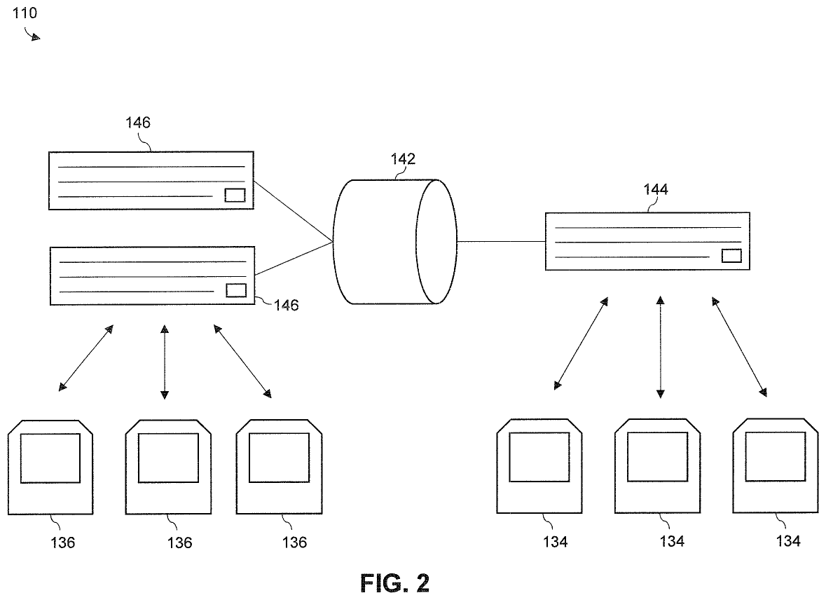

Referring now to FIG. 2, an exemplary preferred embodiment of central registry 110 is illustrated. A database server 142 contains registration data. A registration server 144 in communication with database server 142 provides registration services to registration terminals 134. A verification server 146 in communication with database server 142 provides verification services to point-of-sale terminals 136.

In a simple embodiment, central registry 110 is a single server acting as database server 142, registration server 144, and verification server 146. The single-server embodiment is useful as a low-cost implementation of a central registry 100 for consumption tracking and control programs with limited geographic scope and registered participants. For programs of larger scope, it becomes appropriate to use embodiments with separate server hardware for each of the roles of database server 142, registration server 144, and verification server 146; some embodiments have multiples of each server, as the system 100 allows for expansion of resources as a program grows in number of participants and geographic scope.

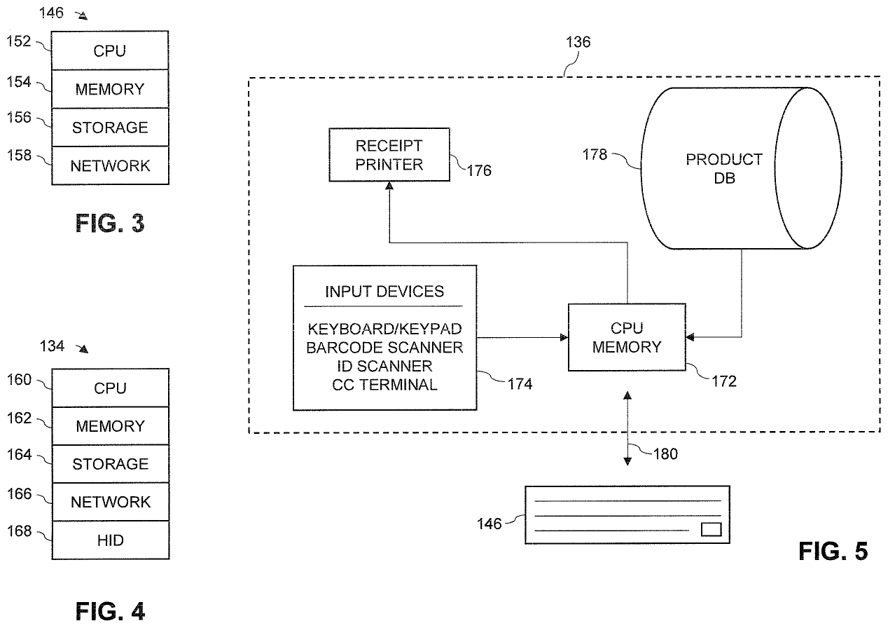

Referring now to FIG. 3, a diagram of exemplary components of a verification server 146 is shown. Database server 142 and registration server 144 have the same structure as far as relates to the illustrated components. More particularly, each verification server 146 has a central processing unit (CPU) 152, non-transitory memory 154, a mass storage device 156 such as a hard drive, flash storage, or other form of mass storage, and network connection hardware 158 enabling verification server 146 to connect to network 120. Similarly, each database server 142 and registration 144 has a CPU 152, non-transitory memory 154, a mass storage device 156, and network connection hardware 158.

Referring now to FIG. 4, a diagram of exemplary components of a registration terminal 134 is shown, including a CPU 160, non-transitory memory 162, a mass storage device 164, network connection hardware 166, and one or more human interface devices (HID) 168. Network connection hardware 166 enables terminal 134 to connect to network 120. A non-limiting list of exemplary HIDs 168 includes computer monitors, keyboards, mouses, touchscreens, keypads, and microphones. HIDs 168 facilitate the entry of data necessary to register a new program participant or update the registration of an existing program participant.

Referring now to FIG. 5, an exemplary point-of-sale (POS) terminal 136 for a retail store is illustrated. Terminal 136 has a controller 172 including a CPU and non-transitory memory, input devices 174, a receipt printer 176, a product database 178, and a network connection 180 allowing terminal 136 to communicate with a verification server 146. Exemplary input devices 174 include a keyboard or keypad, a scanner such as a universal product code (UPC) scanner to read codes from products, an ID card scanner or other scanner, such as a biometric scanner, for identifying program participants, and a credit card terminal for payment processing. Some embodiments of terminal 136 include a receipt printer 176. A product database 178 maintains product information matched to UPCs or other product codes; in some embodiments, product database 178 is external to terminal 136 and accessed through network connection 180 or another network connection.

Some of the described features will not be present in all embodiments of terminal 136. As a non-limiting example, a service provider such as a casino may use a simplified terminal 136 with an ID scanner, controller 172, and network hardware for a network connection 180 to a verification server 146, in order to determine whether to admit an individual into the casino. Such embodiments do not require a product database 178, product scanner, or receipt printer, and so some embodiments lack these and other features unnecessary to their particular use case.

An exemplary terminal 136 for an online store has the same structure as a verification server 146 illustrated in FIG. 3, including a CPU 152, non-transitory memory 154, mass storage device 156, and network hardware 158.

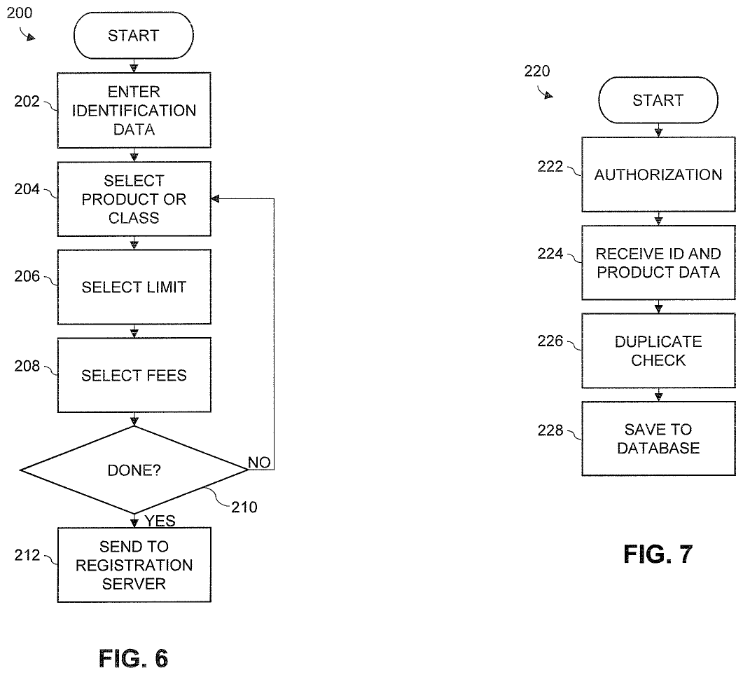

Referring now to FIG. 6, a registration process performed with a registration terminal 134 is illustrated and generally designated 200. Process 200 is performed for registering a new user of system 100 in order to limit or track purchases, and a variant of process 200 is also used to update a registration to add, remove, or change limits and tracked purchases.

In step 202 of process 200, registration terminal 134 receives identification data provided by a user. In preferred embodiments, identification data includes the name and other identifying information of a prospective participant in a program for controlling and verifying transactions. In preferred embodiments, identification data also includes data used to match the participant's records in database 142 of central registry 110 with the participant obtaining a product or service at a POS terminal 136. For example, preferred embodiments are configured to obtain data from a magnetic card stripe, such as a stripe on a government identification card, healthcare provider card, or other card with a magnetic stripe. A magnetic stripe reader attached to a registration terminal 134 is used to obtain the data during registration, and a magnetic stripe reader from the input devices 174 of a POS terminal 134 (see FIG. 5) is used to obtain the data and send it to a verification server 146, which in turn matches it with the participant's records in database 142.

In step 204, the registration terminal 134 presents a user interface to the user through which a product or service, or a class of products and services, is selected. Non-limiting examples include, “cigarettes,” “tobacco products,” and “gambling services.” When a registration is being updated, existing products can be selected for changes or removal, and new products can be selected to add tracking or limits.

In step 206, the registration terminal 134 presents a user interface to the user through which purchase limits, if any are to be applied, are selected. Non-limiting examples of exemplary limits include a complete prohibition on purchase of the selected product, service, or class; a quantity limit during a specified time period, e.g., two packs of cigarettes per week, or twenty ounces of liquor per day; and a decreasing limit over time, e.g. a pack of cigarettes per day for two weeks, followed by a pack every two days for two weeks, and so on until a complete prohibition on purchase. Another exemplary type of limit is a requirement in conjunction with a purchase, such as the selection of a designated driver as a requirement prior to purchase of alcohol.

A time limit is also selected, indicating the duration of participation in the program for the selected products or services. For the time limit, any duration can be selected, including an option for the participant's entire lifetime. When the time limit is reached, the purchase limits and additional fees will no longer be applied.

In step 208, the registration terminal 134 presents a user interface to the user through which additional fees to be added to purchases can be configured. Additional fees can be added in lieu of restrictions or in addition to restrictions. Moreover, preferred embodiments of system 100 (see FIG. 1) provide an option for both fixed and progressive additional fees. By increasing in amount with the number of purchases, a progressive fee discourages overconsumption of the products or services to which it is attached.

When the purpose of registration is only to track the participant's consumption, neither limits nor fees will be selected. When a limits, fees, or tracking is selected for deletion in an existing registration, the selected product, service, or class is marked for a deletion request to be made in step 212, and steps 206 and 208 are skipped for the selected item.

In step 210, registration terminal 134 provides the option to enter data for additional products, services, or classes of products and services to be tracked or limited. If the user selects the option to enter further data, steps 204, 206, and 208 are repeated until all the desired products, services, and classes of products and services have been entered along with any limitations and additional fees for each. Once the user indicates in step 210 that all data has been entered, the process proceeds to step 212.

In step 212, registration terminal 134 sends the collected information from steps 202, 204, 206, and 208 to a registration server 144 (shown in FIG. 2).

Referring now to FIG. 7, a process performed by a registration server 144 (shown in FIG. 2) is illustrated and generally designated 220. Process 220 operates on registration server 144 in conjunction with step 212 (see FIG. 6) of process 200 (see FIG. 6) operating on a registration terminal 134.

In step 222, registration server 144 receives a connection request from registration terminal 134. In a preferred embodiment, a secure sockets layer (SSL) or transport layer security (TLS) handshake (SSL/TLS handshake) is performed, or a similar procedure for creating a secured connection in which cryptographic keys are exchanged is performed. Thus, a secure connection is created between registration terminal 134 and registration server 144. Registration server 144 requires authentication in which registration terminal 134 provides its credentials to ensure that it is authorized to register users in system 100.

In step 224, the registration server 144 receives identification data and product data sent from the registration terminal 134 in step 212 of process 200 (see FIG. 6).

In step 226, the registration server 144 checks the database to ensure that the participant is not already registered. If the participant is already registered, a message is sent to registration terminal 134, causing registration terminal 134 to display an error message, and in some embodiments, allow the user the option of updating the existing registration with the new data. Alternatively, when process 200 (see FIG. 6) was performed for the update of an existing registration, the registration server 144 looks up the registration in database 142 in order to associate the new data to the existing registration.

In step 228, the registration server 144 saves the data received in step 224 to database 142 (shown in FIG. 2).

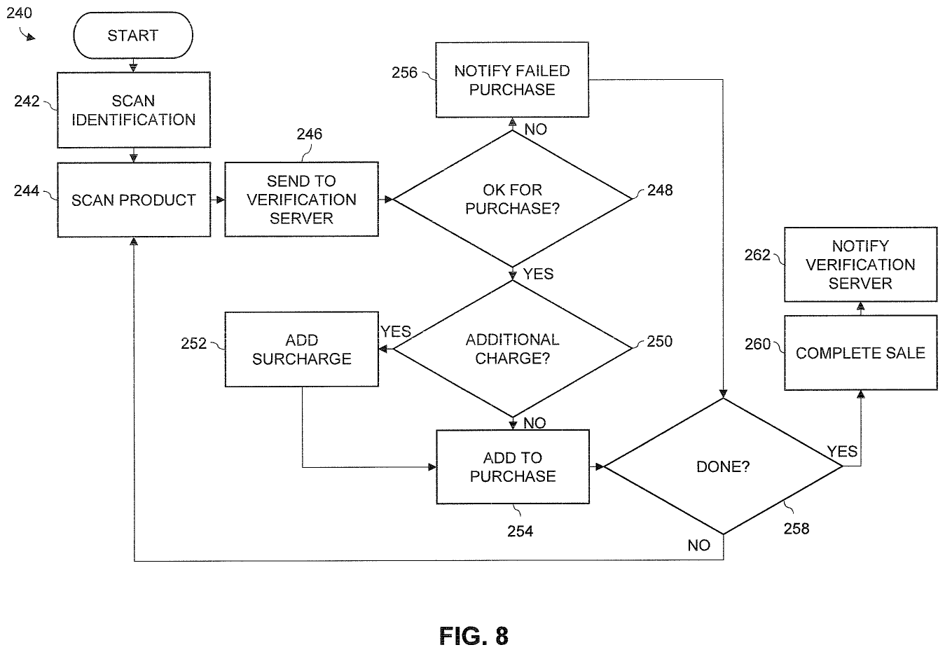

Referring now to FIG. 8, a preferred embodiment of a verification process performed by a POS terminal 136 (shown in FIG. 5) is illustrated and generally designated 240. Process 240 occurs when a purchaser attempts to purchase goods or services. Process 240 is illustrated in the context of purchasing products, but it will be apparent to one of ordinary skill in the art that the same process can also be used with the purchase of services or both goods and services.

In step 242 the purchaser is identified. In a preferred embodiment, this step is performed by scanning a magnetic strip identification card and sending the scanned data to a verification server 146 (shown in FIG. 2).

In step 244, a product to be purchased is identified. In preferred embodiments, the product identification is performed by the ordinary product identification mechanism of a point-of-sale terminal, e.g., by scanning a barcode, entering a product code, or selecting a product from a user interface.

In step 246, the product information is sent to verification server 146 in order to determine whether the purchaser is restricted from purchasing the product.

In step 248, POS terminal 136 receives a response from verification server 146 indicating whether the purchaser is permitted to purchase the product. If so, POS terminal 136 also receives information about whether an additional charge is to be applied to the purchase, and, if so, how much, illustrated as step 250.

If there is an additional charge, it is applied in step 252. The product is added to the purchaser's purchase in step 254. If, however, the verification server 146 indicated that the purchase is not authorized, POS terminal 136 performs step 256 of notifying the operator of terminal 136 and the verification server 146 that an unauthorized purchase is being attempted, and the product is not added to the purchaser's purchase.

In step 258, if more products are being purchased, the prior steps from step 244 are repeated; otherwise, the sale is completed in step 260, and the POS terminal 136 notifies the verification server 146 of the purchased products in step 262.

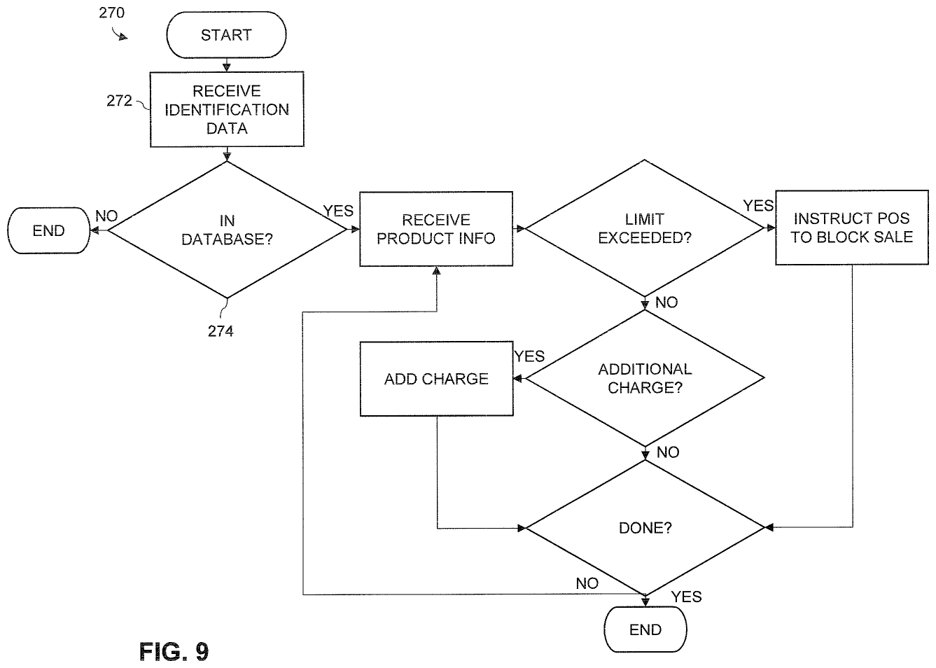

Referring now to FIG. 9, a preferred embodiment of a process performed by a verification server 146 (shown in FIG. 2) is illustrated and generally designated 270. Process 270 is performed cooperatively with process 240 in order to track and control transactions.

After a secure connection is made and a POS terminal 136 (shown in FIG. 2) is authenticated, verification server 146 receives identification data, such as magnetic stripe data or other identifying data, for a purchaser in step 272.

In step 274, verification server 146 looks up the purchaser's record in the database. If a registered participant matching the purchaser's identification is not found, the POS terminal 136 is notified, allowing the merchant to request alternate identification or to determine that the purchaser is not a registered participant and allow the sale to go forward without verification.

In step 276, verification server 146 receives information identifying a product that the purchaser seeks to purchase. In step 278, verification server 146 determines whether purchase limits are in place, including a complete restriction on purchases of the product or service, and whether they would be exceeded by the attempted sale. If the sale would violate a restriction or limit, the verification server 146 notifies the POS terminal 136 in step 280 that the sale of the product or service should be refused. Otherwise, in step 282, verification server 146 determines whether a surcharge or other additional charge should be applied. If so, step 284 is performed, in which the amount is determined and the POS terminal 136 is notified to add the extra fee.

In step 286, if all products and services have now been reviewed, verification server 146 receives confirmation of the sale and the products or services and quantities sold, and process 270 ends. Otherwise, steps 276 onward are repeated until all products and services that the purchaser is attempting to purchase have been reviewed by verification server 146.

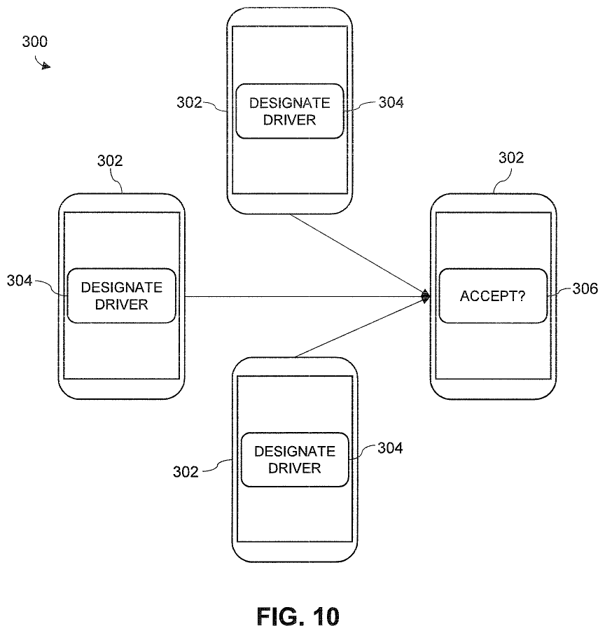

Referring now to FIG. 10, a system for selecting a designated driver in connection with system 100 for verifying and controlling transactions is illustrated and generally designated 300. System 300 includes one or more computing devices through which registered participants select a designated driver, thus enabling each of the involved registered participants, except for the designated driver, to purchase alcohol when such purchases are otherwise restricted by system 100.

In a preferred embodiment, the computing devices are mobile devices 302 running software that communicates with central registry 110 over the Internet. In another embodiment, the computing devices are simply registration terminals 134 or POS terminals 136. In some preferred embodiments, both mobile devices 302 and terminals 134, 136, or both, are operable to select a designated driver.

Participants interact with the prospective designated driver by logging in together to the same terminal 134 or 136, through the software on mobile devices 302 operating to broadcast the presence of registered users looking for other nearby registered users through the communications hardware of mobile devices 302, e.g., Bluetooth, through predetermined “friends” lists, through sharing a code such as an alphanumeric code, QR code, or other form of identifying code, or through some other mechanism for identifying registered users.

Registered participants who seek to purchase alcoholic beverages engage user interfaces 304 to select a designated driver. The registered participant who will act as designated driver is than presented with a user interface 306 which enables the participant to accept the designation as designated driver. If the participant accepts the role of designated driver, the participant's mobile device 302 sends the acceptance and list of participants to central registry 110, e.g. to a registration server 144, verification server 146, or another server connected to database 142 and having the structure illustrated in FIG. 3.

The system functions similarly when a terminal 134 or 136 is used, with users logging in and selecting a designated driver, who accepts the role. The terminal then sends the acceptance and list of participants to central registry 110.

Once the designated driver is accepted and the central registry 110 receives the designation and list of participants, system 100 permits participants except for the designated driver to purchase alcoholic drinks for a predetermined amount of time. If the designated driver was otherwise unrestricted from alcohol purchases, system 100 imposes a temporary restriction on alcoholic purchases during the aforementioned time period.

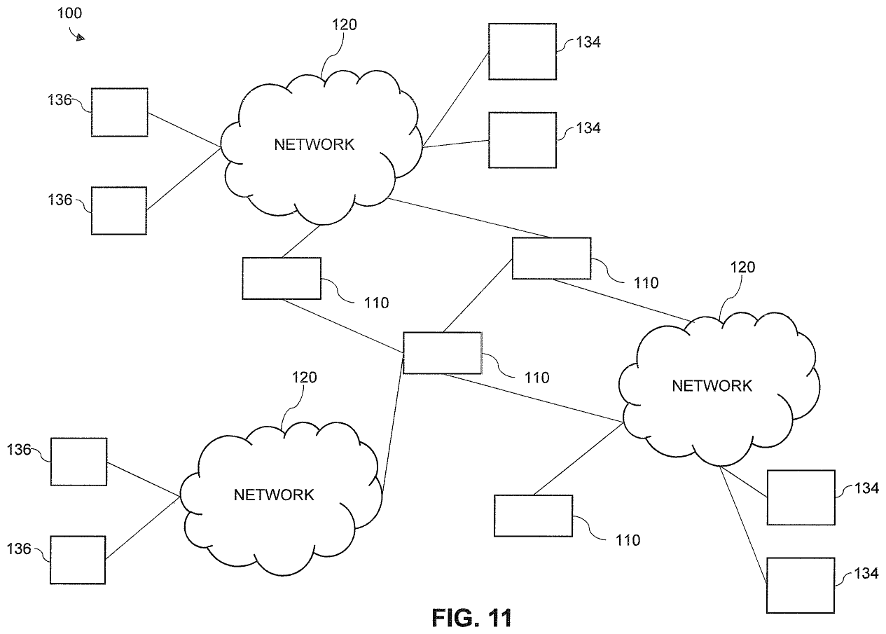

Referring now to FIG. 11, an exemplary preferred embodiment of a system for controlling and verifying transactions is 100 illustrated, showing capabilities and features present in some embodiments of system 100. System 100 is illustrated with multiple networks 120 and multiple central registries 110. These features are independent, such that some embodiments have multiple central registries 110 operating on a single network 120, and some other embodiments have a single central registry 110 operating on multiple networks 120, while yet other embodiments have multiple central registries 110 operating on multiple networks 120, as illustrated. In some embodiments, one of the networks 120 is the internet.

The use of multiple central registries 110 offers backup and load balancing capabilities. The central registries 110 are in communication with each other in order to keep data synchronized and otherwise perform their operations. As illustrated, central registries 110 can communicate directly with each other, e.g. through a private network such as a LAN or private mesh network, or communicate with each other via a network 120. The illustrated embodiment has both types of communication connections.

As illustrated, some embodiments have one or more networks 120 exclusive to registration terminal 134 communication with central registries 110, one or more networks 120 exclusive to POS terminal 136 communication with central registries 110, or both. Such networks 120 exclusive to a particular type of terminal 134 or 136 allow for greater security and are particularly useful where protection of private data is a concern. Moreover, where security is a significant concern, a network 120 can be private between a single terminal 134 or 136 and a central registry 110 (or multiple central registries 110). Where a network 120 is exclusive to a registration terminal 134, a central registry 110 connected to it may lack a verification server 146. Likewise, where a network 120 is exclusive to a POS terminal 136, corresponding central registries 110 may lack registration servers 144.

In embodiments in which one of the networks 120 is the internet, the cost of operating system 100 is reduced where there is an existing internet connection, since terminals 134 and 136 can be joined to the system through the already-existent internet connection. The additional networks 120 are capable of allowing terminals 134 and 136 to join the system where an internet connection is unavailable, or where it would be undesirable to connect a terminal 134 or 136 to the internet.

While there have been shown what are presently considered to be preferred embodiments of the present invention, it will be apparent to those skilled in the art that various changes and modifications can be made herein without departing from the scope and spirit of the invention. Moreover, embodiments containing the various possible combinations of the features disclosed in the above-described embodiments are fully contemplated.

What is claimed is:

1. A system for controlling and verifying transactions, comprising:
one or more networks;
one or more central registries; and
one or more point-of-sale (POS) terminals,
wherein the one or more POS terminals are configured to communicate with a central registry of the one or more central registries through a network of the one or more networks, send data corresponding to a registered participant to the central registry, request authorization for a transaction to be made to the registered participant, and deny the sale if the authorization is denied.

2. The system for controlling and verifying transactions of claim 1, further comprising means for selecting a designated driver from among a group of registered participants.

3. The system for controlling and verifying transactions of claim 2, wherein the one or more central registries are configured to deny authorization for a sale of alcoholic beverages to each registered participant of the group of registered participants until the designated driver is selected.

4. The system for controlling and verifying transactions of claim 3, wherein the one or more central registries are configured to authorize the sale of alcoholic beverages to all registered participants of the group of registered participants except the designated driver when a designated driver is selected.

5. The system for controlling and verifying transactions of claim 1, wherein the one or more central registries comprise a database associating prohibited and limited products and services with registered participants.

6. The system for controlling and verifying transactions of claim 5, wherein the central registries are configured to deny the authorization if the sale comprises a prohibited product or a prohibited service associated with the registered participant and provide a limited authorization if the sale comprises a limited product or a limited service associated with the registered participant.

7. The system for controlling and verifying transactions of claim 6, further comprising one or more registration terminals configured to communicate with a central registry of the one or more central registries through a network of the one or more networks, wherein the central registry is configured to receive information for a new participant and a new list of prohibited products and services from a registration terminal of the one or more registration terminals, and wherein the central registry is configured to add new entries to the database to associate the new participant with the prohibited products and services of the new list of prohibited products and services.

8. The system for controlling and verifying transactions of claim 7, wherein the database further associates surcharged products with the registered participants, and wherein the POS terminals are configured to add a surcharge when the sale comprises a surcharged product associated with the registered participant.

9. The system for controlling and verifying transactions of claim 7, wherein the registration terminals are further configured to receive updates to the prohibited and limited products and services associated with a registered participant and communicate the updates to a central registry of the one or more central registries, and wherein the central registry is configured to store the updates in the database.

10. A method for controlling and verifying transactions, comprising the steps of:
providing one or more networks;
providing one or more central registries;
receiving identification information;
sending the identification information to the central registry;
receiving product information;
sending the product information to a central registry of the one or more central registries;
receiving a response from the central registry; and
refusing transaction of a product if the response from the central registry comprises a denial of authorization to transact.

11. The method for controlling and verifying transactions of claim 10, further comprising the step of adding a surcharge if the response from the central registry comprises a surcharge requirement.

12. The method of controlling and verifying transactions of claim 10, further comprising the step of notifying the central registry of a completed transaction.

13. The method of controlling and verifying transactions of claim 10, wherein the step of receiving product information comprises scanning a barcode, QR code, or other printed code.

14. The method of controlling and verifying transactions of claim 10, wherein the step of receiving identification information comprises scanning an identification card or code based on an identification card.

15. The method of controlling and verifying transactions of claim 10, wherein the identification card is scanned with a magnetic stripe reader or chip reader.

16. A system for controlling and verifying transactions, comprising:
one or more networks;
one or more central registries, each central registry comprising:
a database comprising a list of registered participants,
one or more registration servers, and
one or more verification servers; and
one or more point-of-sale (POS) terminals,
wherein each POS terminal of the one or more POS terminals is configured to communicate with a verification server through the network, send data corresponding to a registered participant of the registered participants to the verification server, request authorization for a transaction to be made to the registered participant, deny the transaction if the authorization is denied, and limit the transaction if a limited authorization is provided.

17. The system for controlling and verifying transactions of claim 16, wherein the database associates a list of prohibited and limited products and services with each registered participant of the registered participants.

18. The system for controlling and verifying transactions of claim 17, wherein the verification server is configured to deny the authorization if the transaction comprises a prohibited product or a prohibited service from the list of prohibited and limited products and services associated with the registered participant and to provide a limited authorization if the transaction comprises a limited product or a limited service from the list of prohibited and limited products and services associated with the registered participant.

19. The system for controlling and verifying transactions of claim 18, further comprising one or more registration terminals, each registration terminal configured to communicate with a registration server through the network, wherein the registration server is configured to receive information for a new participant, a new list of prohibited products and services, and a new list of limited products and services from a registration terminal of the one or more registration terminals, and wherein the registration server is configured to the new participant to the list of registered participants and associate the new list of prohibited products and services and the new list of limited products and services with the new participant.

20. The system for controlling and verifying transactions of claim 19, wherein the registration terminals are further configured to receive updates to the prohibited products and services associated with a registered participant of the list of registered participants and communicate the updates to the registration server, and wherein the registration server is configured to store the updates in the database.

21. The system of controlling and verifying transactions of claim 19, wherein the system is configured to adjust insurance rates and coverage for insurance comprising health, life, vehicle, personal injury, property, general, liability, disability, home owners, long term care, or umbrella insurance.

22. The system of controlling and verifying transaction of claim 19, wherein the system is configured to control use of substances to facilitate overcoming tobacco addiction, alcohol addiction, marijuana addiction, gambling addiction, video game addiction, internet addiction, medication dependency, diet-based addictions and behaviors or adhere to any agreement thereof.
